(19) United States
(12) Patent Application Publication
(10) Pub. No.: US 2015/0247918 A1
(43) Pub. Date: Sep. 3, 2015

(54) METHOD AND APPARATUS FOR TRACKING OBJECTS WITH LOCATION AND MOTION CORRELATION

(71) Applicant: QUALCOMM Incorporated, San Diego, CA (US)

(72) Inventors: Gengsheng ZHANG, Cupertino, CA (US); Sai Pradeep VENKATRAMAN, Santa Clara, CA (US); Benjamin A. WERNER, Santa Clara, CA (US); Weihua GAO, San Jose, CA (US); Ju-Yong DO, Palo Alto, CA (US); Lionel Jacques GARIN, Palo Alto, CA (US)

(73) Assignee: QUALCOMM Incorporated, San Diego, CA (US)

(21) Appl. No.: 14/192,904

(22) Filed: Feb. 28, 2014

(51) Int. Cl. G01S 5/02; G01C 22/00

(52) U.S. Cl. CPC G01S 5/0294; G01S 5/0278; G01C 22/006

(57) ABSTRACT

In a tracking of a position and motion of a device, a set of hypothetical locations of the device is generated. Hypothetical locations among the set are propagated to respective hypothetical next locations, using respective location-specific propagation models associated with the hypothetical locations. Sensor information having correlation to a location of the device is received. An importance weighting for the hypothetical next locations is calculated using the new sensor information. Probable locations of the device are generated using the importance weighting.

### FIELD OF DISCLOSURE

The present application for patent relates to tracking objects, more particularly, to tracking pedestrians through modes of motion and conveyance.

### BACKGROUND

A conventional pedometer can include a compass and accelerometers and can, given a starting position, can track a user's position by a dead reckoning integration of the compass bearing and accelerometer signals. Recent smart phones, tablets, and other mobile devices (interchangeably referenced as “mobile stations” and “mobile devices”) can include accelerometers and compasses that may provide pedometer functionality. Some mobile devices can, for example, provide pedometer functionality as a background process, which can include displaying the user's position, for example, as a lighted dot on a map within a picture-in-picture (PIP) field of the mobile device display.

Known techniques for accelerometer-based pedometer tracking include a particular kind of Bayesian filtering known in the art as “particle filtering.”

However, there are scenarios in which such known accelerometer-based pedometer techniques can misclassify the user's condition between non-moving or static and moving or dynamic. One example is when a user is on a moving walkway or sidewalk (as in an airport). In such a scenario, as the user is being moved along by the moving walkway, he or she will see in the PIP his or her position as a stationary lighted dot, still positioned at the point where he or she stepped on the moving walkway. That may be a negative experience for the user. Similar scenarios include a user hopping on a train or entering an elevator. In addition to the immediate negative experience for the user, PIP may perform certain actions based on the classification such as unnecessarily and incorrectly updating user device's location algorithms.

One commonality of these scenarios is that the user, although, holding the mobile device, is supported by a moving platform. Another moving platform scenario is a mobility challenged person using his or her mobile device while in a moving wheelchairs. Another type of scenario in which known accelerometer-based pedometer techniques can misclassify the user's condition as static, even though the user and the mobile device are moving, is when the user places his or her mobile device on a support not tightly coupled to the steps of the user, for example, when the user places the mobile device on a shopping cart.

Conventional techniques for detecting moving walkways are known, but such techniques require special sensors at the ends of the walkway that are recognized by a device on the user end or with the assistance of a server.

### SUMMARY

The following summary is not an extensive overview of all contemplated aspects, and is not intended to identify key or critical elements nor delineate the scope of any aspect. Its sole purpose is to present some concepts of one or more aspects in a simplified form as a prelude to the more detailed description that is presented later.

Example methods according to one or more exemplary embodiments may provide tracking position and motion of a device, and may include generating a set of hypothetical locations of the device, propagating each of at least a sub-set of the hypothetical locations to a respective hypothetical next location, based on respective location-specific propagation models associated with the hypothetical locations. In an aspect, example methods according to one or more exemplary embodiments may include receiving sensor information having correlation to a location of the device, and calculating an importance weighting, based in part on the new sensor information, for at least a plurality of the hypothetical next locations, and generating a corresponding plurality of hypothetical next location importance weightings. In a further aspect, example methods according to one or more exemplary embodiments may include generating probable locations of the device based at least in part on the importance weighting.

In an aspect, example methods according to one or more exemplary embodiments may include in propagating each of at least a sub-set of the hypothetical locations, propagating a first hypothetical location among the at least a sub-set of the hypothetical locations according to a first propagation model associated with the first hypothetical location, to a hypothetical next first location, and propagating a second hypothetical location among the at least a sub-set of the hypothetical locations according to a second propagation model associated with the second hypothetical location, and different than the first propagation model, to a hypothetical next second location.

In an aspect, example methods according to one or more exemplary embodiments may include the first hypothetical location being given as corresponding to a geographically stationary platform for the device, and the second hypothetical location being given as corresponding to a moving platform for the device. In a related aspect, the first propagation model may include a probable direction and velocity of the device relative to the geographically stationary platform, and the second propagation model may include a probable direction and velocity of the moving platform relative to a given reference.

In an aspect, example methods according to one or more exemplary embodiments may include, in the sensor information, accelerometer information and received signal information. In a further aspect, example methods according to one or more exemplary embodiments may include, in calculating the importance weighting of the hypothetical next first location, applying a first relative weighting between the accelerometer information and the received signal information and, in calculating the importance weighting of the hypothetical next second location, applying a second relative weighting between the accelerometer information and the received signal information different than the first relative weighting.

One example apparatus, according to one more exemplary embodiments, may provide for tracking a position of a mobile device, and may include a sensor including a wireless receiver for receiving wireless signals having correlation to a location of the device and generating, in response, sensor information signals, a processor coupled by an interface to the wireless transceiver, configured to receive and execute machine-readable instructions, a display coupled to the processor, and a computer-readable storage medium coupled to the processor. According to one more exemplary embodiments, the computer-readable storage medium may be configured to store machine-readable instructions, including machine-readable instructions that, when executed by the processor, cause the processor to generate a set of hypothetical locations of the device; propagate each of at least a sub-set of the hypothetical locations to a respective hypothetical next location, based on respective location-specific propagation models associated with the hypothetical locations; receive new sensor information from the sensor, having correlation to a location of the device; calculate an importance weighting, based in part on the new sensor information, for at least a plurality of the hypothetical next locations, and generate a corresponding plurality of hypothetical next location importance weightings; generate probable locations of the device based at least in part on the importance weighting; and display an information on the display based, at least in part, on the generated probable locations.

Another example apparatus, according to one more exemplary embodiments, may provide for tracking a position of a mobile device, and may include means for generating a set of hypothetical locations of the device; means for propagating each of at least a sub-set of the hypothetical locations to a respective hypothetical next location, based on respective location-specific propagation models associated with the hypothetical locations; means for receiving sensor information having correlation to a location of the device; means for calculating an importance weighting, based in part on the new sensor information, for at least a plurality of the hypothetical next locations, and generating a corresponding plurality of hypothetical next location importance weightings; and means generating probable locations of the device based at least in part on the importance weighting.

In an aspect, means for propagating each of at least a sub-set of the hypothetical locations may be configured for propagating a first hypothetical location among the at least a sub-set of the hypothetical locations according to a first propagation model associated with said first hypothetical location, to a hypothetical next first location, and propagating a second hypothetical location among the at least a sub-set of the hypothetical locations according to a second propagation model associated with said second hypothetical location, and different than the first propagation model, to a hypothetical next second location.

Example computer products according to one more exemplary embodiments may include a computer-readable medium comprising instructions, which, when executed by a processor in a portable device, may cause the processor to perform operations carrying out a method for tracking a position of the device. In an aspect, the instruction may include instructions that cause the processor apparatus to generate a set of hypothetical locations of the device; propagate each of at least a sub-set of the hypothetical locations to a respective hypothetical next location, based on respective location-specific propagation models associated with the hypothetical locations; receive sensor information having correlation to a location of the device; calculate an importance weighting, based in part on the new sensor information, for at least a plurality of the hypothetical next locations, and generating a corresponding plurality of hypothetical next location importance weightings; and generate probable locations of the device based at least in part on the importance weighting.

### BRIEF DESCRIPTION OF THE DRAWINGS

FIG. 1 shows a simplified schematic of a mobile station configured for performing in accordance with one or more exemplary embodiments.

FIG. 2 shows one example flow of operations in a process of particle filter tracking with location and user mode dependent propagation model.

FIG. 3 shows one hypothetical example floor-plan for describing various tracking and classification operations further to one or exemplary embodiments.

FIG. 4 shows one example flow of operations in a process of particle filter tracking with location dependent propagation model.

FIG. 5 shows superposed on FIG. 4 one hypothetical example initial distribution of particles in an area multiple propagation model regions, in one process according to one or more exemplary embodiments.

FIG. 6 shows one example importance weighted sampling of the FIG. 5 initial distribution of particles.

FIG. 7 shows one hypothetical importance filtered sampling of the FIG. 6 example weighted sampling.

FIG. 8 shows one example hypothetical resampling, based on the FIG. 7 filtered, weighted sampling.

FIG. 9 shows a hypothetical sampling movement that may result from applying location-dependent propagation models to the FIG. 8 example hypothetical resampling.

FIG. 10 shows a hypothetical shifted resampling based on the FIG. 9 movement.

FIG. 11 shows a hypothetical threshold filtering of a resampling leaving only one cluster.

FIG. 12 shows a hypothetical display of a beacon corresponding to the FIG. 11 cluster.

### DETAILED DESCRIPTION

The detailed description set forth below in connection with the appended drawings is intended as a description of exemplary embodiments and is not intended to represent the only embodiments in which the present invention can be practiced. The word “exemplary” (and variants thereof) as used herein means serving as an example, instance, or illustration. Any aspect or design described herein as “exemplary” is not necessarily to be construed as preferred or advantageous over other aspects or designs. Rather, use of the word “exemplary” is only intended to illustrate example applications of concepts using simplified concrete examples.

Various specific details are also described, to facilitate a person of ordinary skill in the art in readily obtaining, through this disclosure in its entirety, a sufficient understanding of relevant concepts to practice according to one or more of the various exemplary embodiments. Such persons, though, upon reading this entire disclosure may see that various embodiments and aspects of one or more embodiments may be practiced without, or with alternatives to one or more of these specific details. In other instances, certain well-known structures and devices are shown in block diagram form to avoid obscuring the various novel ties of the exemplary embodiments.

Various aspects or features will be presented in terms of systems that may include a number of devices, components, modules, and the like. It is to be understood and appreciated that various systems may include additional devices, components, modules, and so forth, and/or may not include all devices, components, modules, and so on, discussed in connection with the figures. A combination of these approaches may also be used.

The terms “engine”, “component”, “module”, “system” and the like, as used herein, are intended to refer to a functional entity, which may be embodied in hardware, firmware, a combination of hardware and software, software, or software in execution. A “component” may be, but is not limited to being, a process running on a processor, a processor, an object, an executable, a thread of execution, a program, and/or a computer. By way of illustration, both an application running on a computing device and the computing device can be a component.

The term “includes,” as used in either the detailed description or the claims, is intended to be inclusive in a manner similar to the term “comprising” as “comprising” is interpreted when employed as a transitional word in a claim. The term “or,” as used in either the detailed description or the claims, is intended to mean an inclusive “or” rather than an exclusive “or.” In addition, the articles “a” and “an” as used in this disclosure should generally be construed to mean “one or more” unless specified otherwise or clear from the context to be directed to a singular form.

The term “location”, except where expressly stated otherwise or where made clear from a particular context to have a different meaning, does not mean an exact position, but rather means a vicinity or region that may vary in extent based on the implementation and the particular circumstances.

In an aspect, an annotated floor plan of pedestrian accessible areas of a given building can be provided to a user's “smart phone” or other mobile station, either prior to or upon the user entering the building. For example, a “push” mapping information service can be provided, having a wireless transceiver with a coverage that can include an area proximal to an entrance to the building. The user's mobile station can be provided with an application allowing the push service access to, for example, a dedicated floor plan file in the mobile station's memory. The building can be, for example, an airport or similar scale building having, in accordance with various exemplary embodiments, moving walkways, escalators, and/or elevators. In a further aspect, the floor plan provided to the mobile station includes annotation of the moving walkways, escalators, and/or elevators including, for each, statistical parameters of their respective speeds, and ingress and egress areas of a fixed floor proximal to their entry and exit points. In one alternative aspect, parameters characterizing moving walkways, escalators and/or elevators can be provided to the user's mobile station at locations throughout the building.

In accordance with one or more exemplary embodiments, a plurality of access points (APs) or other wireless signal sources can be distributed throughout the building.

In an aspect, the user's mobile station can be provided with a “heat” map aligned with and overlaid on the floor plan, that characterizes, for each of a given plurality of points on the floor plan, the expected measurement values that the mobile station will obtain, when located at that point, if it measures particular signals it will receive from a sub-plurality of the APs having respective radiation patterns covering the point. The particular signals are hereinafter referred to as “AP signals,” but this term will be understood to mean signals from a plurality of APs or any other designated transmitters. The expected measurement values for each point in the heat map can include, for example, without limitations, received signal strength indicator (RSSI), round trip time (RTT), or both. As for techniques to generate the heat map, conventional heat map generation techniques can be used and, therefore, except where incidental to particular example operations in accordance with one or more exemplary embodiments, further detailed description is omitted. Regarding the density or granularity of the heat map, i.e., the number of signal measurement points per unit area of the floor plan, i.e., it will be understood by a person of ordinary skill upon reading this entire disclosure that such density can be determined based on, for example, and without limitation, the target accuracy of the system, and the gradient of the signal characteristic represented by the heat map.

In a related aspect, the mobile station can be configured with RF sensors capable measuring the RSSI, a return transit time (RTT), and a Doppler shift (DPL) for given AP signals.

In an aspect, the mobile station can be provided with sensors, including accelerometers having sensitivity sufficient to detect whether the user is walking or standing. In a further aspect, the and mobile station can include a compass, and the accelerometers may have a sensitivity sufficient to detect pedestrian gate and stride length, i.e., walking speed, such that digital processing resources of the mobile station, in addition to detecting whether the user is walking or standing, can estimate, to a given statistical accuracy, the user's position by dead reckoning.

In an aspect, the mobile station can be configured with a recursive Monte Carlo sampling filter, alternatively referred to as a “particle filter” to track the user while walking within the building, based on a combination of the heat map, the floor plan, and measurements from the above-described RF sensors and accelerometers.

In an aspect, the mobile station can be configured to detect instances where the user has, with a significant likelihood, employed a pedestrian conveyance device, for example, has likely stepped on to a moving walkway or escalator, or likely stepped into an elevator. In a further aspect, the mobile station can be configured to particularly classify such detected instances among a set of given user conveyance states, and then, based on the classification, dynamically select or adapt particle filter parameters with a goal of optimizing tracking accuracy and processing overhead. In an aspect, the classification can be based on the accelerometer information, and/or the Doppler signal, as will be described in greater detail in later sections of this disclosure.

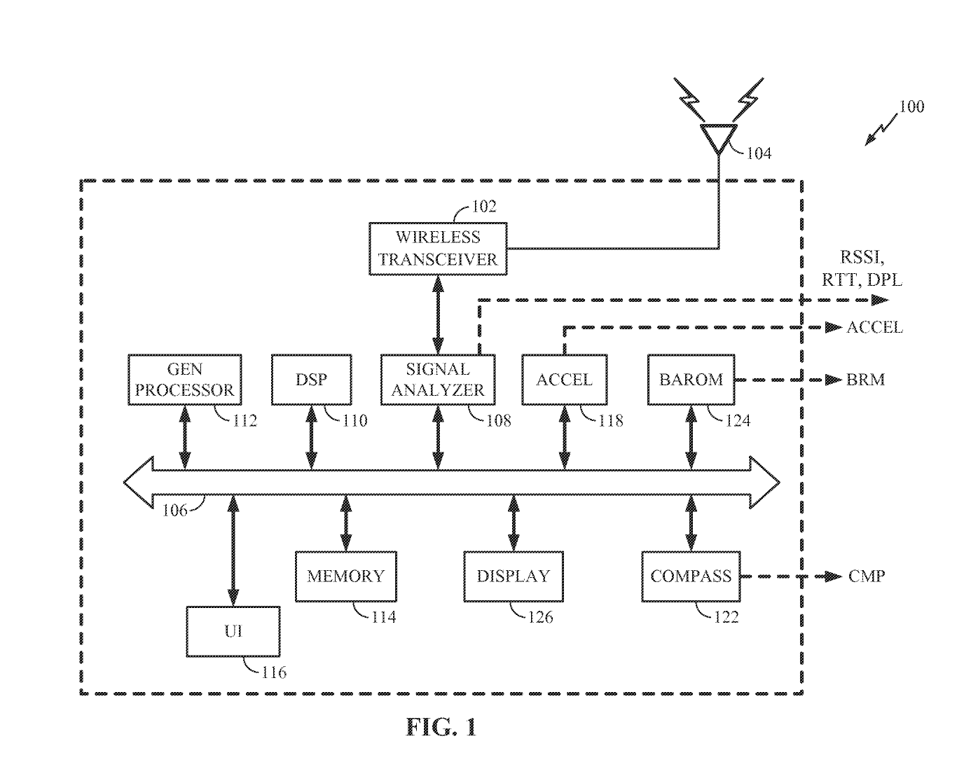

FIG. 1 is a schematic diagram of one example mobile station (MS) 100 according to an embodiment. Referring to FIG. 1, in an aspect MS 100 may also comprise a wireless transceiver 102 capable of transmitting and receiving wireless signals TX/RV via an antenna 104 over a wireless communication network (not shown). The wireless transceiver 102 may be connected to bus 106 by a signal analyzer 108 that may include wireless transceiver bus interface. The wireless transceiver 102 and antenna 104 may comprise multiple wireless transceivers (not separately shown) and antennas (not separately shown) capable of wireless communication according to, for example, and without limitation, WiFi, CDMA, WCDMA, LTE and Bluetooth.

Continuing to refer to FIG. 1, MS 100 may comprise digital signal processor(s) (hereinafter “processor(s) or DSP(s)) 110 connected to the bus 106, general-purpose processor(s) 112 connected to the bus 106 and memory 114, having a computer-readable storage medium, such as RAM, ROM, FLASH, or disc drive. In various embodiments, functions or processes, such as processes according to the flow 400 shown in FIG. 4, may be performed by, for example, general-purpose processor(s) 112 and/or DSP(s) 110, in response to execution of one or more machine-readable instructions stored in memory 114. MS 100 may include a user interface 116 may comprise any one of several devices such as, for example, a speaker, microphone, display device, vibration device, keyboard, touch screen, just to name a few examples.

In an aspect, MS 100 may also comprise accelerometers 118 configured to respond to acceleration of MS 100 in three orthogonal axes (not explicitly shown) and output a acceleration signal “ACCEL” (not shown in FIG. 1), a compass sensor 122, configured to general a compass signal “CMP” (not shown in FIG. 1), each coupled to the bus 106. In a further aspect, MS 100 may include a barometer 124.

The MS 100 can also include, as previously identified, a signal analyzer 108 configured to identify a received signal strength and generate a received signal strength indicator (RSSI) data, round trip time (RTT) data, and Doppler (DPL) data. The MS 100 may include a display 126. It will be understood that although the user interface 116 is shown separate from the display 126, these may be implemented by a common hardware device, i.e., a touch-screen display (not separately shown).

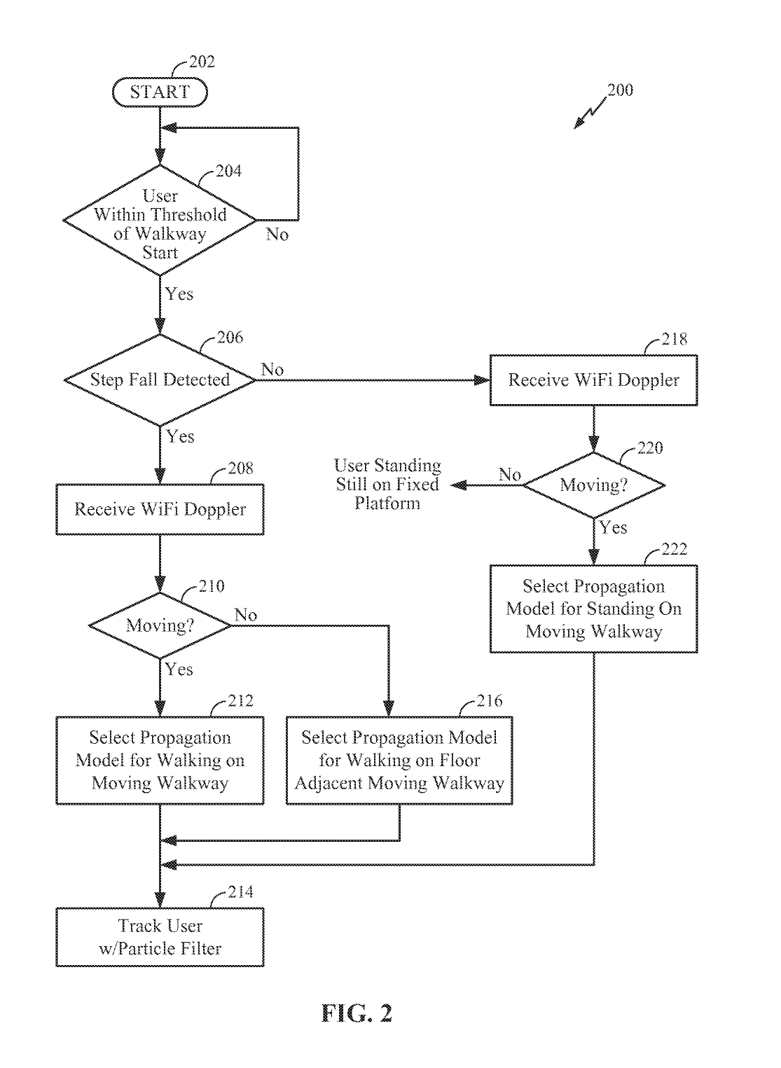

FIG. 2 shows one example flow 200 of operations in a process of particle filter tracking using location and user mode dependent propagation models. Example operations according to the flow 200 will be described in reference to the FIG. 3 example floor plan 300.

Referring to FIG. 3, the floor plan 300 is a hypothetical pedestrian area (not separately shown) within, for example, an airport or an indoor shopping mall, having a general area 302 connected by a doorway 304 to a corridor 306. The corridor 306 includes an ingress area 308 to a moving walkway 310, and a corridor region 312 adjacent the moving walkway 410. The moving walkway 310 will be assumed as moving in the direction “A” at a given velocity that may be defined, for example, in meters per minute. The direction and velocity may be defined relative to a given reference, e.g., an assigned zero or start position on the floor plan 300. It will be understood that the moving walkway 310 is a simplified drawing, and is not necessarily drawn to scale.

Example operations can begin at “START” 202, which can assume a user, holding the FIG. 1 example MS 100 or equivalent, having walked through the FIG. 3 doorway 304, but still being to the left (looking at FIG. 3) of the ingress area 308. It will be assumed that the user's MS 100 has the floor plan 300, with annotations describing the corridor 306, the ingress area 308, the moving walkway 310, and the corridor region 312, which is adjacent the moving walkway 310. The annotations may include, for example, the direction “A” and velocity statistics, which may include a mean and a variance. In one example, it may be assumed that the user's MS 100 has acquired his or her location and is tracking the user using, for example, known, conventional techniques. Known, conventional techniques, if used, can be, for example, dead reckoning based on the ACCEL and CPM data, and/or known, conventional triangulation—if three or more AP signals of suitable quality are being received.

Referring to FIGS. 2 and 3, example operations according to the flow 200 can continue to track the user's position until at 204, the position is determined, with an acceptable probability, as being within a threshold of the moving walkway start, i.e., the FIG. 3 ingress area 308. In an aspect, the flow 200 can then proceed to 206 to estimate whether the user is continuing to walk (i.e., is in a “static” state) or is continuing to walk (i.e., is in a “dynamic” state). In one aspect, the estimation at 206 can be based on detecting a step fall, e.g., the accelerometer 118 ACCEL signals. Referring to FIG. 2, if the estimation at 206 indicates the user is still walking, there are two possible scenarios. The first is that the user is walking on the moving walkway 310. The second is that, due to inaccuracy in the estimation at 206, or the user changing his or her mind, the user is walking on a geographically stationary platform, for example the corridor region 312, instead of walking on the moving walkway 310. In an aspect, determining which of these two scenarios exists can include, at 208, receiving DPL (e.g., WiFi Doppler) from the signal analyzer 108 and, at 210, comparing the DPL data to a threshold (not explicitly visible in FIG. 2).

Continuing to refer to FIGS. 2 and 3, if the answer at 210 is “YES” it is likely that the user is walking on the moving walkway 310. In an aspect, operations according to the flow 200 can then go to 212 and select a propagation model for a particle filter tracking at 214 of the user on the moving walkway 310. The selected propagation model can be used to shift the particles, i.e., the hypothetical locations of the user, during a particle filter tracking to correspond to the user's actual rate and direction of movement, thereby better ensuring tighter clustering of samples about an area likely including the user's actual location. Example operations illustrating concepts and benefits of particle filtering using dynamically selected propagation models are described in greater detail in later sections of this disclosure.

Referring to FIGS. 2 and 3, if the answer at 210 is “NO”, meaning the Doppler data does not indicate the MS 100 is moving at a velocity corresponding to the rate of the moving walkway 310, the most likely scenario is that the user is walking on the fixed floor surface, for example the corridor region 312. This may be due to either error in the estimation at 206, or the user changing his or mind. In an aspect, operations according to the flow 200 can then go to 216 and select a propagation model for a particle filter tracking of the user walking on the fixed floor of the corridor region 312. The propagation model selected at 216 may, for example, be a default model having a given rate of rate of walking and using, as the direction of walking, the direction A. In an aspect, the propagation model selected at 216 can be custom adapted to the particular user based on the ACCEL and CMP signals.

Referring to FIGS. 2 and 3, the above-described example operations according to the flow 200 assumed that answer at 206 is “YES”, i.e., that the ACCEL signal indicates the user is continuing to walk after being detected in the ingress area 308. In another example, the answer at 206 is “NO, meaning the user, at least as indicated by the ACCEL signals, has ceased walking after entering the ingress area 308. There are two possible scenarios. The first is that the user is standing on the moving walkway 310. The second is that, for example, due to inaccuracy in the estimation at 206, or the user changing his or mind, the user is still standing on the fixed floor surface, for example, near the ingress area 308. Determining which of these two scenarios exists can be accomplished by receiving, at 218, DPL from the signal analyzer 108 and, at 2220, comparing the DPL data to a threshold (not explicitly visible in FIG. 2).

If the answer at 220 is “YES” it is likely that the user is standing on the moving walkway 310. In an aspect, operations according to the flow 200 can then go to 222 and select a propagation model of the user standing on the moving walkway 310, and then to 214 to track the user. If the answer at 220 is “NO”, meaning the DPL signals do not indicate the MS 100 is moving at a velocity corresponding to the rate of the moving walkway 310, the most likely scenario is that the user is standing on the fixed floor surface, for example, in the corridor region 312.

FIG. 4 shows one example flow 400 of operations in a process of particle filter tracking with location dependent propagation models. As will be appreciated, operations according to the example flow can include the MS 100 receiving propagation model commands from an external source, the propagation model commands can include at least one of a first propagation model, for example, associated with the moving walkway 310, and a second propagation model, for example, associated with fixed floor areas such the corridor region 312.

Operations according to the flow 400 are described assuming the user's MS 100 has been provided with a map of the floor plan 300 and, aligned with and overlaid on the map of the floor plan 300, a heat map, represented as 450 in FIG. 4, that characterizes, for each of a given plurality of points on the floor plan 300, the expected measurement values that the MS 100 will obtain, when located at that point, if it measures particular signals it will receive from a given sub-plurality of the APs having respective radiation patterns covering the point. The heat map values for its point can include received signal strength indicator (RSSI), round trip time (RTT), or both.

In an aspect, the heat map 450 can comprise importance weighting information that can indicate a conditional probability of a first hypothetical location, i.e., a particle generated in accordance with the flow 400, as described in greater detail later, with respect to values of the sensor information, e.g., RSSI and or RTT, and conditional probability of a second hypothetical location with respect to values of the sensor information, or both.

In overview, processes as represented by the flow 400 can provide tracking position and motion of a device, e.g., the MS 100, and may comprise generating a set of hypothetical locations of the device and propagating each of at least a sub-set of the hypothetical locations to a respective hypothetical next location. In an aspect, the propagating to respective hypothetical next locations can be based on respective location-specific propagation models associated with the hypothetical location. In an aspect, processes represented by the flow 400 may include receiving sensor information having correlation to a location of the device. In a related aspect, such processes may include calculating an importance weighting, based in part on the new sensor information, for at least a plurality of the hypothetical next locations, and generating a corresponding plurality of hypothetical next location importance weightings. In an aspect, processes represented by the flow 400 may include generating probable locations of the device based at least in part on the importance weighting.

In addition, in processes represented by the flow 400, generating probable locations of the device may comprise generating a set of resampling hypothetical locations of the device, according to a location distribution based, at least in part, on the plurality of hypothetical next location importance weightings. Processes represented by the flow 400 may further include propagating each of at least a sub-set of the set of resampling hypothetical locations to a respective resampling hypothetical next location, based on respective location-specific propagation models associated with the respective resampling hypothetical locations. Such processes may further include receiving new sensor information having correlation to a location of the device, and calculating an importance weighting, based at least in part on the new sensor information, for at least a plurality of the resampling hypothetical next locations. As will be understood, generating probable locations of the device may be based at least in part on the importance weighting of at least a plurality of the resampling hypothetical next locations.

Example operations according to the flow 400 will be described as beginning at 402 where the user's position is determined, with an acceptable probability, as being within the FIG. 3 ingress area 308. As described in operations according to the FIG. 2 flow 200, the determination at 404 of FIG. 4 that the user is in the ingress area 308 carries two inter-related uncertainties. One is the uncertainty as to the user's location and the other is the corresponding uncertainty as to whether the user is being moved by the moving walkway 310. It will be appreciated, from reading this disclosure, that example operations in the flow 400 can resolve, according to an aspect, the above-described uncertainty, by using two or more location-dependent propagation models concurrently, as will be described in greater detail. It also will be appreciated from reading the description that operations according to this aspect can be additional to, or in the absence of the Doppler shift determination described in reference to FIG. 2.

It will be appreciated from the description that operations according to the FIG. 4 flow 400 can provide, for example, a method for tracking position and motion of a device, namely the mobile station (e.g., MS 100), comprising generating a set of hypothetical locations of the device, propagating each of at least a sub-set of the hypothetical locations to a respective hypothetical next location, based on respective location-specific propagation models associated with the hypothetical locations, receiving sensor information having correlation to a location of the device, calculating an importance weighting, based in part on the new sensor information, for at least a plurality of the hypothetical next locations, and generating probable locations of the device based at least in part on the importance weighting.

Referring to FIGS. 3 and 4, in one example, operations according to the flow 400 can start at 404, when the user location is determined, with an acceptable certainty, as being in the ingress area 308. The determination may be, for example, as described for the determination at 204 of the FIG. 2 flow 200. In an aspect, operations according to the flow 400 can then go to 404 and generate an initial sampling of R particles, each of the R particles being a hypothetical location of the user in the floor plan 300. The particles generated at 402 will be arbitrarily labeled “PK(i, j)”, with “j” initialized at “0”, and “i” ranging from 0 to R−1. The “i” index is a count of re-samplings described later in greater detail.

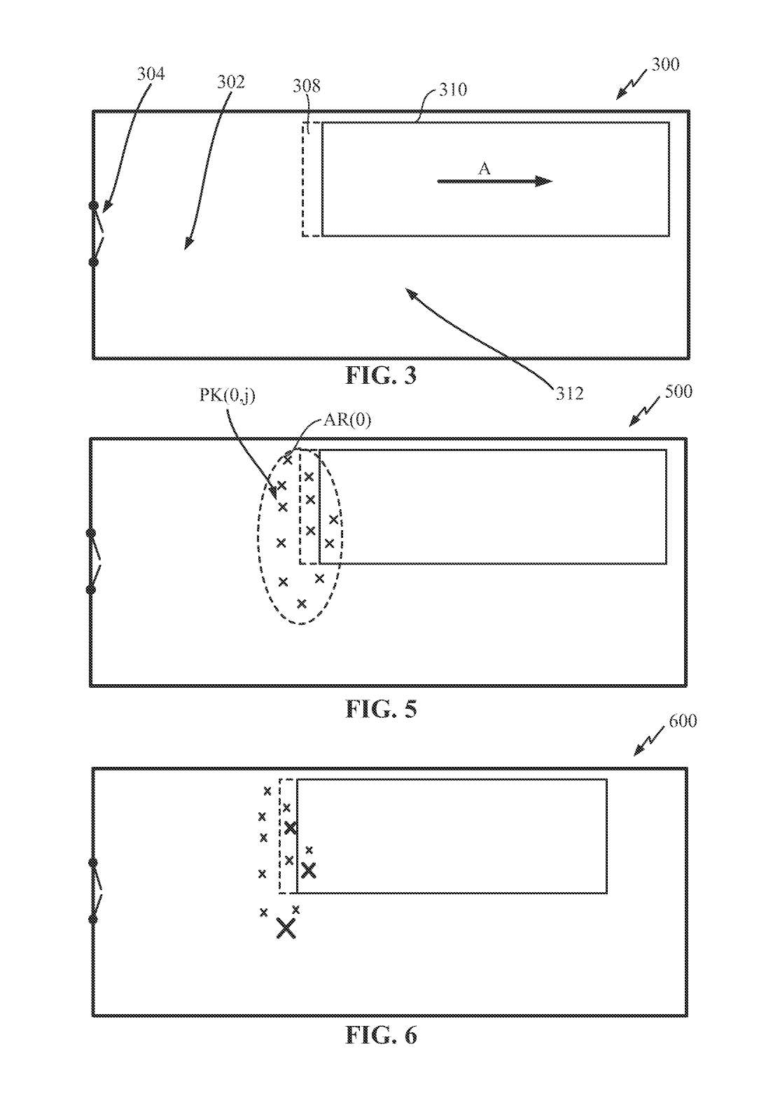

Referring to FIGS. 4 and 5, in one example, the initial sampling generated at 404 may constrain the samples to a given area, labeled on FIG. 5 as “AR (0)”. For purposes of illustrating concepts, the FIG. 5 AR (0) encompasses area on the moving walkway 310, and areas not on the moving walkway 310, i.e., area on the fixed floor. In an aspect, the probability density function (pdf) of the initial sampling at 404 can be, for example, uniform. This assumption, however, is only for purposes of example, and is not any limitation on any embodiment. For example, it may be known that the probability of the user, if on the moving walkway 310, has a significantly higher probability of being on the right side than being on the left side (with “right” being from the perspective facing the direction “A”). In such an instance, the pdf of the initial sampling at 404 can be selected to place a higher density of particles PK(i, j) on the right side of the moving walkway 310 than on the left side.

Referring again to FIG. 5, according to the above-described uniform distribution of the initial sampling at 404, 12 “X” marks represent example positions of the 12 particles PK(0, j) substantially being evenly distributed in AR(0). There is no particular ordering as to which FIG. 5 “X” corresponds to which particle PK(0, j). The example R of 12 is primarily for visual clarity of FIG. 5, as it will be understood that initial sampling 404 may use an R value higher than R=12, for example R may be one hundred or greater. As previously described, the initial sampling 404 uniformly distributes the particles PK(0, j) over the initial area AR (0), with AR (0) being much smaller than the entire floor plan 300. It will understood that establishing the user as being within an area such as AR(0) can be omitted and, instead, the initial sampling at 404 may distribute the particles PK(0, j), j=0 to R−1, over the entire floor plan 300. It will also be appreciated that the number of iterations to acquire the user location may, in such an instance, be significantly greater.

In the example instance of the FIG. 4 initial sampling at 404 that is shown at FIG. 5, all the particles PK(0, j) have the same initial weight. In an aspect, after generating the initial sampling at 404 of the example 12 particles PK(0, j), j=0 to 11, operations according to the flow 400 can go to 406 and receive sensor data from the MS 100. In an aspect, the RSSI data and RTT data is received. Operations according to the flow 400 may then proceed to 408 to calculate an importance weighting, W(0, j), for each of the R particles generated by the initial sampling at 404. It will be understood that the “i” index being “0” for the first iteration is the reason the importance weightings are referred to as “W(0, j),” and the particles are referred to as PK(0, j) for the present operation at 408. General operations relating to 408 may reference importance weightings as “W(i, j),” and particles as PK(0, j).

Referring to FIG. 4, and continuing with description of a first iteration, in an aspect, calculating W(0, j) at 408 for each particle PK(0, j) can include receiving importance weighting information, for example, retrieving or accessing a given database, e.g., heat map 450 of conditional probabilities of MS 100 sensor information values, assuming each of a plurality of hypothetical positions. In an example, the heat map 450 may include conditional probabilities of MS 100 sensors receiving the measurement RSSI and/or RTT received at 406 if the MS 100 were in fact at the hypothetical position defined by PK(0, j). The calculation of the importance weightings W(0, j) can be performed using known, conventional techniques and, therefore, further detailed description is omitted. The heat map 450 can be constructed from empirical measurement or computer simulation, or both. It will be understood that the heat map 450 can be constructed using known, conventional techniques and, therefore, further detailed description is omitted.

FIG. 6 shows one example hypothetical result 600 of an importance weighting at 408 being applied to the 12 example particles PK(0, j) of the initial sampling, with the magnitude of the importance weights W(0, j) being represented by the magnification (or reduction) of the size of “X”, and a bolding of the “X” representing particles PK(0, j) having hypothetical stronger weights W(0, j).

Referring to FIG. 4, in example operations according to the flow 400, after calculating at 408 the importance weightings W(0, j), for j=0 to 11, operations may proceed to 410 and perform a threshold filtering of the particles PK(0, j). Again, it will be understood that the “i” index being “0” for the first iteration is the reason the importance weightings are referred to as “W(0, j),” and the particles are referred to as PK(0, j) for the present operation at 410. General operations relating to 410 may reference importance weightings as “W(i, j),” and the particles as PK(0, j).

The threshold filtering at 410 can be by comparing their respective importance weightings W(0, j) to a given importance threshold, labeled “TH”. Selection of the TH value can be according to known, conventional techniques and, therefore, further detailed description is omitted. As will be understood by persons of ordinary skill from reading the present disclosure, an objective of the threshold filtering at 410 is to remove unlikely candidate positions of the user's MS 100. The output of the threshold filtering at 410 may be referred to as the candidate particles CPK(0, k), for k=0 to K, where K is less than or equal to R. The value of K relative to R establishes the percentage of the first sampling 400 particles PK(0, j) removed by the threshold filtering at 410. The percentage may depend on, for example, the TH value.

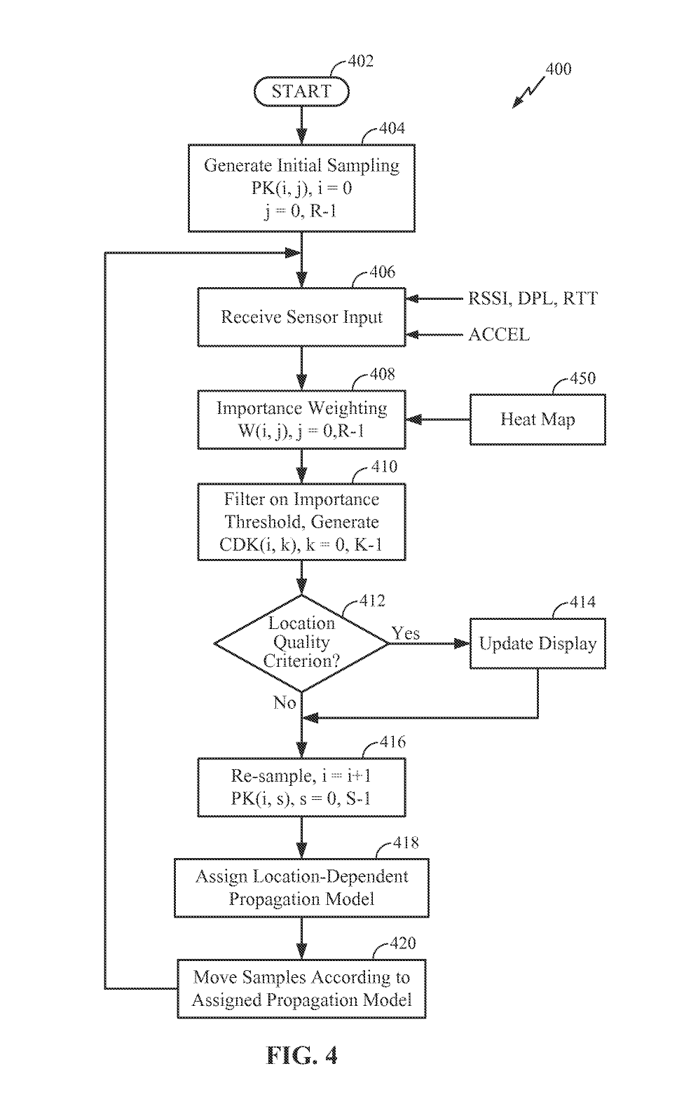

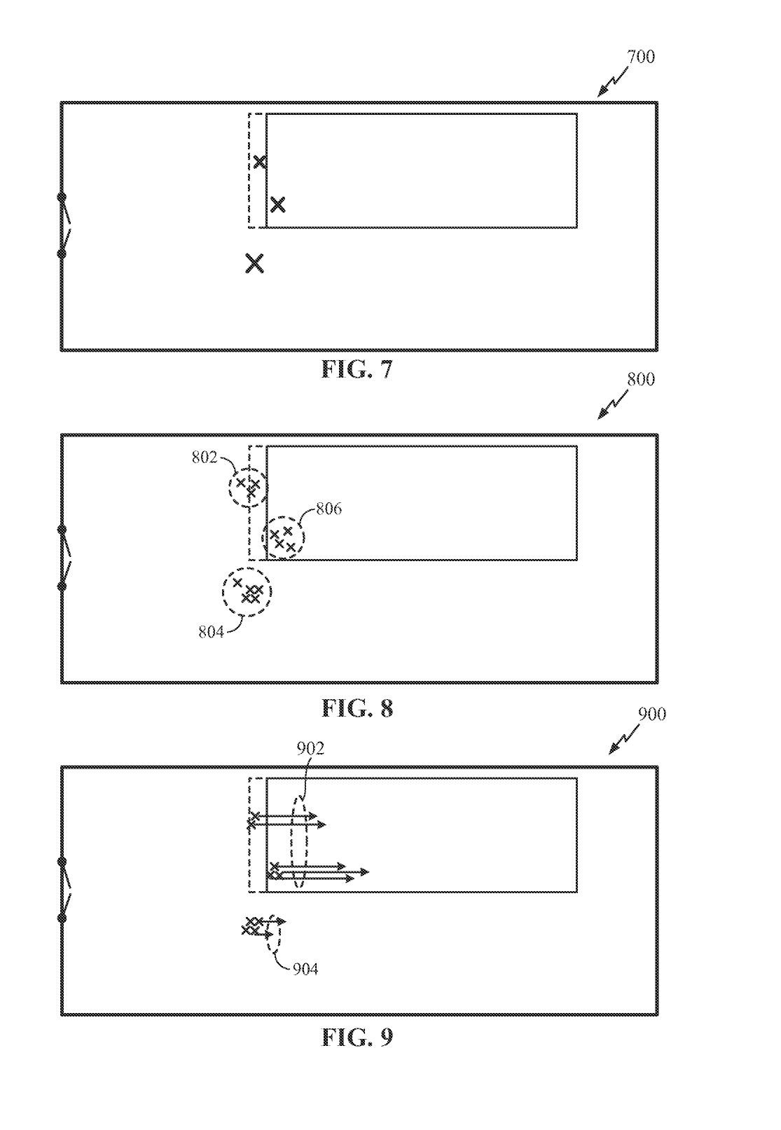

FIG. 7 shows one example hypothetical filtered sampling 700 that can result from the threshold filtering at 410 applied to the hypothetical weighted sampling generated at 408. The filtered sampling 700 assumes, as an arbitrary example, that TH eliminated all except three of the initial sampling particles PK(0, j).

Referring to FIG. 4, in an aspect, after the threshold filtering at 410 a test criterion may be applied at 412 to the candidate particles CDK (0, k), for k=0 to K. The test criterion may, for example, be a measuring of clustering (not explicitly shown in FIG. 4). If the test criterion at 412 is met, operations can include, at 414, an updating of a display of the MS 100. The updating of the display at 414 can be, for example, represented by a light beacon, and/or a change in color or intensity of a light beacon representing the user relative to the floor plan 300.

Referring to FIG. 4, either directly after the test criterion is applied at 412 or after the display update at 414, operations according to the flow 400 can proceed to 416, where they can increment the iteration count “i” to “i+1” and perform a re-sampling to generate resampled particles, PK(i, s) for s=0 to S−1. The value S can be, but is not necessarily the same as R. In other words, the re-sampling at 416 can generate more, or less, or the same quantity of samples as generated at the initial sampling at 404. The resampled particles PK(i, s), for s=0 to S−1, can be according to a probability distribution based, at least in part, on the distribution and relative amplitude of the importance weights W(0, j) of the candidate particles CDK(0, k). In an aspect the re-sampling at 416 can generate the re-sampled particles PK(i, s) by multiplying (in terms of count, not weight) one or more of the candidate particles CPK(0, k), for k=0 to K−1, by a value corresponding to the magnitude of its importance weight W(0, j).

FIG. 8 shows one example of one hypothetical resampling 800, based on the FIG. 7 filtered sampling 700. The FIG. 8 hypothetical resampling 800 assumes S is equal to R, which is 12 for this example. The hypothetical resampling 800 places 3 particles, each represented by an “X”, in the region 802, 4 particles in the region 804 and 5 particles in the region 806. It will be understood that each of the 3 particles is a resampling hypothetical location. The resampling particles in the regions 802, 804, and 806 are shown spaced apart but may be directly atop one another. Spacing between the resampling particles in the regions 802, 804, and 806 can be introduced by the noise increment when applying the location-dependent propagation model, as will be described in greater detail in reference to FIGS. 4 and 9.

Referring to FIG. 4, in example operations according to the flow 400, after the resampling at 416 generates the resampled particles PK(1, s), for s=0 to S−1, according to a pdf established by the importance weighting at 408 and threshold filtering at 410, the resampled particles PK(1, s) are, at 418, assigned propagation models based on their location on the floor plan 300. For example, resampled particles PK(1, s) that represent a hypothetical location on a fixed floor surface (e.g., corridor region 312) can be assigned a propagation model corresponding to the estimated walking speed and direction of the user. In an aspect, these values may be calculated from the ACCEL and CMP sensor signals. In another aspect, pre-calculated speed and direction values may be used. Resampled particles PK(1, s) that represent a resampled hypothetical location that falls on the moving walkway 310 surface can be assigned a propagation model corresponding to the estimated speed and noise (e.g., variance of the speed) of the moving walkway 310.

Continuing to refer to FIG. 4, after the assigning at 418 the location-dependent propagation models can, at 420, be applied to move or shift the resampled particles PK(1, s), for s=0 to S−1 to an expected future position, based on the present position, and the expected movement as represented by the propagation model. In an aspect, a random noise (not explicitly shown) may be selected for each resampled particle PK(1, s), based at least in part on the particular propagation model. For example, a random noise corresponding to fluctuations in velocity of the moving walkway 310 can be added to that velocity when moving resampled particles PK(1, s) that are on the moving walkway 310. Similarly, a random noise corresponding to fluctuations in pedestrian speed can be added to the resampled particles PK(1, s) that are assigned the propagation model of a person walking on the fixed floor area adjacent the moving walkway 310.

FIG. 9 shows a hypothetical particle movement 900 that may result from applying the FIG. 4 block 420 shifting or movement of resampled particles PK(1, s), for s=0 to S−1, using the location-dependent propagation models assigned at 418. In the hypothetical particle movement 900, the resampled particles PK(1, s) within the FIG. 8 regions 802 and 806 are each moved a distance (shown by respective arrow lengths). The distance (i.e., arrow lengths) corresponds to the expected velocity of the moving walkway 310 with a random noise increment. The random noise increment is graphically represented by the differing lengths of the arrows, but is not necessarily drawn to scale, and does not necessarily correspond to the actual statistics of any actual moving walkway. Similarly, in the hypothetical particle movement 900 the resampled particles PK(1, s) within the FIG. 8 region 804, are each moved a distance (shown by respective arrow lengths) that corresponds to the expected or probable velocity and probable direction of a pedestrian at that area of the floor plan 300.

It will be appreciated that the resampled particles PK(1, s) can represent a new set of hypothetical locations of the MS 100, and the FIG. 4 flow 400 includes propagating a first hypothetical location according to a first propagation model associated with that first hypothetical location, to a hypothetical next first location, and propagating a second hypothetical location according to a second propagation model associated with that second hypothetical location, and different than the first propagation model, to a hypothetical next second location.

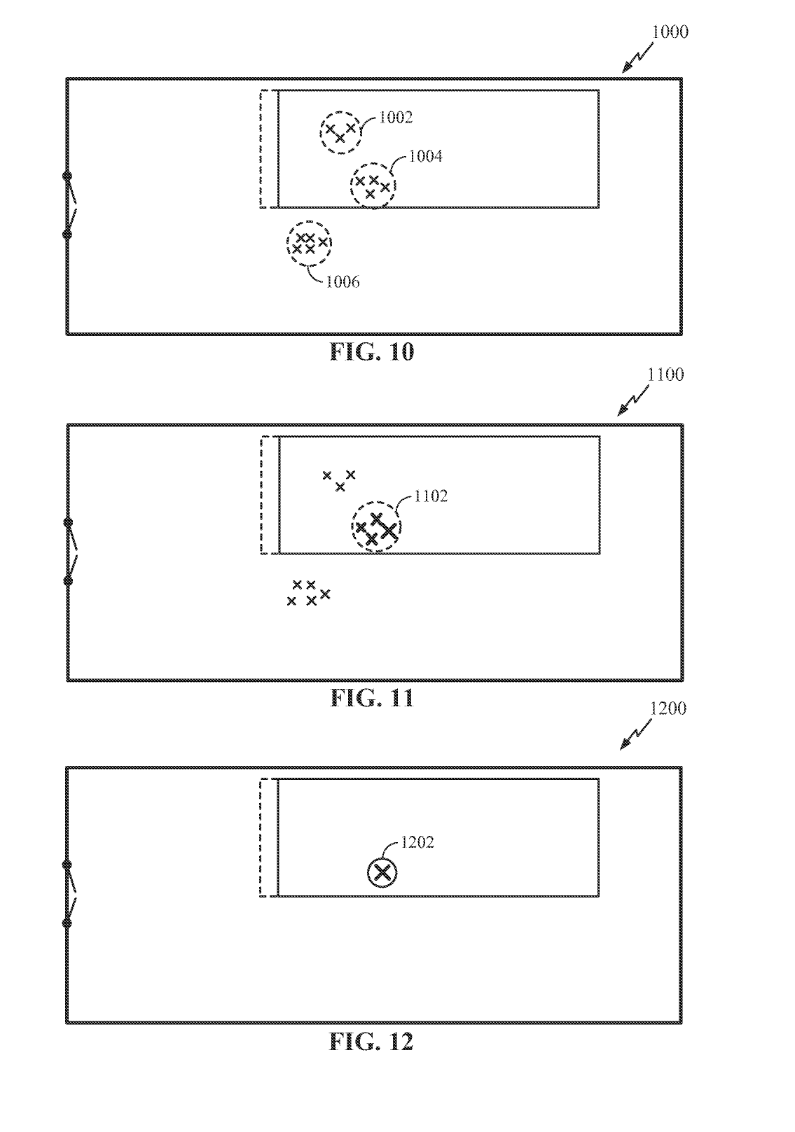

Referring to FIG. 4, in operations according to the flow 400, after the movement of the resampled particles PK(1, s), for s=0 to S−1 according to their respectively assigned location-dependent propagation models, the operations can return to 406, receive an update of sensor data, and repeat the above-described loop. In an aspect, the loop can repeat until the resampled particles PK(i, j) have a clustering indicating no ambiguity and a pdf with an acceptable spread. For example, referring to FIG. 10, the hypothetical particle movement 900 shown on FIG. 9 may result in the FIG. 10 hypothetical shifted resampling 1000, having a cluster 1002 with 3 resampled particles PK(1,j), cluster 1004 with 4 resampled particles PK(1,j), and cluster 1006 with 5 resampled particles PK(1,j). The resampled particles are identified as “PK(1, j)” because the “i” index was incremented to “1” in the previous loop or iteration.

Referring to the FIG. 11 arbitrarily selected weighting 1100, one hypothetical of such a weighting may result in only the cluster 1102, i.e., one cluster, of resampled particles PK(1,j) passing the threshold filtering at 410 of the FIG. 4 flow 400. Referring to the FIG. 12 user position display 1200, in one hypothetical example, the FIG. 11 cluster 1102 will be assumed as meeting a location quality criterion at 412 of FIG. 4. A result can be a display of a lighted beacon 1202 or equivalent, in the FIG. 12 user position display 1200. In an aspect, the lighted beacon 1202 can be a centroid of the FIG. 11 cluster 1102.

Referring to FIG. 4, operations according to the flow 400 can repeat until the user has exited the building corresponding to the FIG. 3 floor plan 300. It will be understood that as the user walks through the building, he or she may step onto, and off other moving walkways, or escalators and, at each such instance, a repeat of the above-described process of selecting, and applying location-dependent propagation models may be performed.

In a further aspect, the FIG. 3 example floor plan 300 can be modified to include an elevator (not explicitly shown) having an ingress area (not explicitly shown) corresponding to the FIG. 3 ingress area 308 at which pedestrians have a high probability of entering the elevator. In a related aspect, the FIG. 2 example flow 200 can be configured to include, for example, immediately after detecting the user entering the ingress area, taking a reading of the MS 100 barometer data BAROM, and proceeding to update the display to indicate the user changing floors.

In view of exemplary systems shown and described above, methodologies that may be implemented in accordance with the disclosed subject matter, will be better appreciated with reference to various flow charts. While, for purposes of simplicity of explanation, methodologies are shown and described as a series of blocks, it is to be understood and appreciated that the claimed subject matter is not limited by the number or order of blocks, as some blocks may occur in different orders and/or at substantially the same time with other blocks. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram. Further, the various methods disclosed herein can include employing a processor executing computer executable instructions stored on a computer readable storage medium to implement the methods.

It will be appreciated that data store (e.g., memories) components described herein may include or may be implemented using volatile memory, nonvolatile memory, or both. Nonvolatile memory may include or may be implemented with any non-volatile memory technology capable of meeting performance requirements pertaining to the particular memory function implemented, which can be readily ascertained by persons of ordinary skill in the art upon reading this disclosure, and may include, as illustrative but limitative examples, read only memory (ROM), programmable ROM (PROM), electrically programmable ROM (EPROM), electrically erasable ROM (EEPROM), or flash memory. Volatile memory may include or may be implemented with any volatile memory technology capable of meeting performance requirements pertaining to the particular memory function implemented, which can be readily ascertained by persons of ordinary skill in the art upon reading this disclosure, and may include, as illustrative but limitative examples, synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the various aspects is intended to comprise, without being limited to, these and any other suitable types of memory.

It is to be understood that aspects described herein may be implemented by hardware, software, firmware or any combination thereof. When implemented in software, functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. In addition, any connection is properly termed a computer-readable medium. For example, if software is transmitted from a website, server, or other remote source using a coaxial cable, fiber optic cable, twisted pair, digital subscriber line (DSL), or wireless technologies such as infrared, radio, and microwave, then coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Various illustrative logics, logical blocks, modules, and circuits described in connection with aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform functions described herein. A general-purpose processor may be a microprocessor, but, in the alternative, processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described herein.

For a software implementation, techniques described herein may be implemented with modules (e.g., procedures, functions, and so on) that perform functions described herein. Software codes may be stored in memory units and executed by processors. Memory unit may be implemented within processor or external to processor, in which case memory unit can be communicatively coupled to processor through various means as is known in the art. Further, at least one processor may include one or more modules operable to perform functions described herein.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product may include a computer readable medium having one or more instructions or codes operable to cause a computer to perform functions described herein.

Further, the steps and/or actions of a method or algorithm described in connection with aspects disclosed herein may be embodied directly in hardware, in a software module executed by a processor, or a combination thereof. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to processor, such that processor can read information from, and write information to, storage medium. In the alternative, storage medium may be integral to processor. Further, in some aspects, processor and storage medium may reside in an ASIC. Additionally, ASIC may reside in a user terminal. In the alternative, processor and storage medium may reside as discrete components in a user terminal Additionally, in some aspects, the steps and/or actions of a method or algorithm may reside as one or any combination or set of codes and/or instructions on a machine readable medium and/or computer readable medium, which may be incorporated into a computer program product.

While the foregoing disclosure discusses illustrative aspects and/or embodiments, it should be noted that various changes and modifications could be made herein without departing from the scope of described aspects and/or embodiments as defined by the appended claims. Accordingly, described aspects are intended to embrace all such alterations, modifications and variations that fall within scope of appended claims. Furthermore, although elements of described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for tracking position and motion of a device, comprising:
generating a set of hypothetical locations of the device;
propagating each of at least a sub-set of the hypothetical locations to a respective hypothetical next location, based on respective location-specific propagation models associated with the hypothetical locations;
receiving sensor information having correlation to a location of the device;
calculating an importance weighting, based in part on the new sensor information, for at least a plurality of the hypothetical next locations, and generating a corresponding plurality of hypothetical next location importance weightings; and
generating probable locations of the device based at least in part on the importance weighting.

2. The method of claim 1, wherein propagating each of at least a sub-set of the hypothetical locations includes
propagating a first hypothetical location among the at least a sub-set of the hypothetical locations according to a first propagation model associated with said first hypothetical location, to a hypothetical next first location, and
propagating a second hypothetical location among the at least a sub-set of the hypothetical locations according to a second propagation model associated with said second hypothetical location, and different than the first propagation model, to a hypothetical next second location.

3. The method of claim 2, further comprising:
receiving propagation model commands from an external source,
wherein the propagation model commands include at least one of the first propagation model and the second propagation model.

4. The method of claim 3, further comprising:
receiving importance weighting information from an external source, including a conditional probability of the first hypothetical location with respect to values of the sensor information, a conditional probability of the second hypothetical location with respect to values of the sensor information, or both.

5. The method of claim 3, further comprising:
receiving importance weighting information from an external source, including,
for the first hypothetical location, at least one given value of the sensor information and a given conditional probability of the device, if located at the first hypothetical location, receiving the at least one given value, and
for the second hypothetical location, another at least one given value of the sensor information and another given conditional probability of the device, if located at the second hypothetical location, receiving the another at least one given value of the sensor information.

6. The method of claim 2,
wherein the first hypothetical location is given as corresponding to a geographically stationary platform for the device, and the second hypothetical location is given as corresponding to a moving platform for the device, and
wherein the first propagation model includes a probable direction and velocity of the device relative to the geographically stationary platform, and the second propagation model includes a probable direction and velocity of the moving platform relative to a given reference.

7. The method of claim 6, further comprising:
receiving propagation model commands from an external source,
wherein the propagation model commands include the probable direction, or the velocity of the moving platform, or both.

8. The method of claim 2, wherein the sensor information includes accelerometer information and received signal information, and
wherein calculating the importance weighting of the hypothetical next first location applies a first relative weighting between the accelerometer information and the received signal information and calculating the importance weighting of the hypothetical next second location applies a second relative weighting between the accelerometer information and the received signal information different than the first relative weighting.

9. The method of claim 8,
wherein the first hypothetical location is given as corresponding to a geographically stationary platform for the device, and the second hypothetical location is given as corresponding to a moving platform for the device, and
wherein the first propagation model includes a probable direction and velocity of the device relative to the geographically stationary platform, and the second propagation model includes a probable direction and velocity of the moving platform relative to a given reference.

10. The method of claim 8, wherein the received signal information includes Doppler shift of a received wireless signal.

11. The method of claim 8, wherein the received signal information includes received signal strength of a received wireless signal.

12. The method of claim 1, wherein generating probable locations of the device comprises:
generating a set of resampling hypothetical locations of the device, according to a location distribution based, at least in part, on the plurality of hypothetical next location importance weightings;
propagating each of at least a sub-set of the set of resampling hypothetical locations to a respective resampling hypothetical next location, based on respective location-specific propagation models associated with the respective resampling hypothetical locations;
receiving a new sensor information having correlation to a location of the device; and
calculating an importance weighting, based at least in part on the new sensor information, for at least a plurality of the resampling hypothetical next locations,
wherein generating probable locations of the device is based at least in part on the importance weighting of at least a plurality of the resampling hypothetical next locations.

13. The method of claim 12, wherein propagating each of at least a sub-set of the set of resampling hypothetical locations includes
propagating a first hypothetical location in the set of resampling hypothetical locations according to a first propagation model associated with that first hypothetical location, to a hypothetical next first location, and
propagating a second hypothetical location in the set of resampling hypothetical locations according to a second propagation model associated with that second hypothetical location, and different than the first propagation model, to a hypothetical next second location.

14. The method of claim 13, wherein the sensor information includes accelerometer information and received signal strength information, and
wherein calculating the importance weighting of the hypothetical next first location applies a first relative weighting between the accelerometer information and the received signal strength information and calculating the importance weighting of the hypothetical next second location applies a second relative weighting between the accelerometer information and the received signal strength information different than the first relative weighting.

15. The method of claim 14,
wherein the first hypothetical location is given as corresponding to a geographically stationary platform for the device, and the second hypothetical location is given as corresponding to a moving platform for the device, and
wherein the first propagation model includes a probable direction and velocity of the device relative to the geographically stationary platform, and the second propagation model includes a probable direction and velocity of the moving platform relative to a given reference.

16. The method of claim 15, further comprising:
receiving propagation model commands from an external source, wherein the propagation model commands include at least one of the first propagation model and the second propagation model, and receiving importance weighting information from an external source, including a conditional probability of the hypothetical next first location with respect to values of the sensor information, a conditional probability of the hypothetical next first location with respect to values of the sensor information, or both.

17. An apparatus for tracking a position of a mobile device, comprising:
a sensor including a wireless receiver for receiving wireless signals having correlation to a location of the device and generating, in response, sensor information signals;
a processor coupled by an interface to the wireless transceiver, configured to receive and execute machine-readable instructions;
a display coupled to the processor;
a computer-readable storage medium coupled to the processor, configured to store machine-readable instructions, including machine-readable instructions that, when executed by the processor, cause the processor to
generate a set of hypothetical locations of the device;
propagate each of at least a sub-set of the hypothetical locations to a respective hypothetical next location, based on respective location-specific propagation models associated with the hypothetical locations;
receive new sensor information from the sensor, having correlation to a location of the device;
calculate an importance weighting, based in part on the new sensor information, for at least a plurality of the hypothetical next locations, and generate a corresponding plurality of hypothetical next location importance weightings;
generate probable locations of the device based at least in part on the importance weighting; and
display an information on the display based, at least in part, on the generated probable locations.

18. The apparatus of claim 17, wherein the machine-readable instructions stored in the memory that cause the processor to propagate each of at least a sub-set of the hypothetical locations include instructions that, when executed by the processor, cause the processor to
propagate a first hypothetical location among the at least a sub-set of the hypothetical locations according to a first propagation model associated with said first hypothetical location, to a hypothetical next first location, and
propagate a second hypothetical location among the at least a sub-set of the hypothetical locations according to a second propagation model associated with said second hypothetical location, and different than the first propagation model, to a hypothetical next second location.

19. The apparatus of claim 17, wherein the machine-readable instructions stored in the memory that cause the processor to generate probable locations of the device include instructions that, when executed by the processor, cause the processor to:
generate a set of resampling hypothetical locations of the device, according to a location distribution based, at least in part, on the plurality of hypothetical next location importance weightings;
propagate each of at least a sub-set of the set of resampling hypothetical locations to a respective resampling hypothetical next location, based on respective location-specific propagation models associated with the respective resampling hypothetical locations;
receive a new sensor information from the sensor, having correlation to a location of the device; and
calculate an importance weighting, based at least in part on the new sensor information, for at least a plurality of the resampling hypothetical next locations,
wherein the machine-readable instructions that, when executed by the processor, cause the processor to generate probable locations cause the processor to base the probable locations, at least in part, on the importance weighting of at least a plurality of the resampling hypothetical next locations.

20. The apparatus of claim 19, wherein the machine-readable instructions stored in the memory that cause the processor to propagate each of at least a sub-set of the set of resampling hypothetical locations include instructions that, when executed by the processor, cause the processor to:
propagate a first hypothetical location in the set of resampling hypothetical locations according to a first propagation model associated with that first hypothetical location, to a hypothetical next first location, and
propagate a second hypothetical location in the set of resampling hypothetical locations according to a second propagation model associated with that second hypothetical location, and different than the first propagation model, to a hypothetical next second location.

21. The apparatus of claim 20, wherein the sensor further includes an accelerometer configured to detect an acceleration sand generate, in response, an accelerometer information,
wherein the sensor further includes a signal strength detector coupled to the wireless received and configured to generate, in response to a received signal, a received signal strength information,
wherein the machine-readable instructions stored in the memory that cause the processor to calculate the importance weighting of the hypothetical next first location cause the processor to apply a first relative weighting between the accelerometer information and the received signal strength information, and
wherein the machine-readable instructions stored in the memory that cause the processor to calculate the importance weighting of the hypothetical next second location cause the processor to apply a second relative weighting between the accelerometer information and the received signal strength information different than the first relative weighting.

22. An apparatus for tracking position and motion of a device, comprising:
means for generating a set of hypothetical locations of the device;
means for propagating each of at least a sub-set of the hypothetical locations to a respective hypothetical next location, based on respective location-specific propagation models associated with the hypothetical locations;
means for receiving sensor information having correlation to a location of the device;
means for calculating an importance weighting, based in part on the new sensor information, for at least a plurality of the hypothetical next locations, and generating a corresponding plurality of hypothetical next location importance weightings; and
means generating probable locations of the device based at least in part on the importance weighting.

23. The apparatus of claim 22, wherein the means for propagating each of at least a sub-set of the hypothetical locations is configured for
propagating a first hypothetical location among the at least a sub-set of the hypothetical locations according to a first propagation model associated with said first hypothetical location, to a hypothetical next first location, and
propagating a second hypothetical location among the at least a sub-set of the hypothetical locations according to a second propagation model associated with said second hypothetical location, and different than the first propagation model, to a hypothetical next second location.

24. The apparatus of claim 23, further comprising:
means for receiving a wireless signal having correlation to a location of the device and generating, in response, a received signal information; and
means for sensing an acceleration and generating, in response, an accelerometer information,
wherein the new sensor information includes the received signal information and the accelerometer information,
wherein the means for calculating the importance weighting of the hypothetical next first location is configured to apply a first relative weighting between the accelerometer information and the received signal information, and
wherein the means for calculating the importance weighting of the hypothetical next second location is configured to apply a second relative weighting between the accelerometer information and the received signal information different than the first relative weighting.

25. The apparatus of claim 24,
wherein the first hypothetical location is given as corresponding to a geographically stationary platform for the device, and the second hypothetical location is given as corresponding to a moving platform for the device, and
wherein the first propagation model includes a probable direction and velocity of the device relative to the geographically stationary platform, and the second propagation model includes a probable direction and velocity of the moving platform relative to a given reference.

26. The apparatus of claim 25, further comprising:
means for receiving propagation model commands from an external source,
wherein the propagation model commands include the probable direction, or the velocity of the moving platform, or both.

27. The apparatus of claim 22, wherein means generating probable locations of the device is configured for:
generating a set of resampling hypothetical locations of the device, according to a location distribution based, at least in part, on the plurality of hypothetical next location importance weightings;
propagating each of at least a sub-set of the set of resampling hypothetical locations to a respective resampling hypothetical next location, based on respective location-specific propagation models associated with the respective resampling hypothetical locations;
receiving a new sensor information having correlation to a location of the device; and
calculating an importance weighting, based at least in part on the new sensor information, for at least a plurality of the resampling hypothetical next locations,
wherein generating probable locations of the device is based at least in part on the importance weighting of at least a plurality of the resampling hypothetical next locations.

28. A computer product having a computer-readable medium comprising instructions, which, when executed by a processor in a portable device the processor to perform operations carrying out a method for tracking a position of the device, comprising instructions that cause the processor to:
generate a set of hypothetical locations of the device;
propagate each of at least a sub-set of the hypothetical locations to a respective hypothetical next location, based on respective location-specific propagation models associated with the hypothetical locations;
receive sensor information having correlation to a location of the device;
calculate an importance weighting, based in part on the new sensor information, for at least a plurality of the hypothetical next locations, and generating a corresponding plurality of hypothetical next location importance weightings; and
generate probable locations of the device based at least in part on the importance weighting.

29. The computer product of claim 28, wherein the instructions that, when executed by the processor, cause the processor to propagate each of at least a sub-set of the hypothetical locations include instructions that, when executed by the processor, cause the processor to:
propagate a first hypothetical location among the at least a sub-set of the hypothetical locations according to a first propagation model associated with said first hypothetical location, to a hypothetical next first location, and
propagate a second hypothetical location among the at least a sub-set of the hypothetical locations according to a second propagation model associated with said second hypothetical location, and different than the first propagation model, to a hypothetical next second location.

30. The computer product of claim 29, wherein the computer-readable medium further includes instructions that, when executed by the processor, cause the processor to:
receive propagation model commands from an external source,
wherein the propagation model commands include at least one of the first propagation model and the second propagation model.
